(19) United States
(12) Patent Application Publication
(10) Pub. No.: US 2008/0061464 A1
(43) Pub. Date: Mar. 13, 2008

(54) Multi-Layered, Variable-angled, Non-Crimped Fabric for Reinforcement of Composite Materials

(76) Inventor: Charlie Bartol Krulic III, Anderson, SC (US)

Correspondence Address: CHARLIE BARTOL KRULIC, 309 BRITTANY PARK, ANDERSON, SC, 29621, US

(21) Appl. No.: 11/864,973

(22) Filed: Sep. 29, 2007

Related U.S. Application Data
(62) Division of application No. 11/005,210, filed on Dec. 7, 2004, now abandoned.

(51) Int. Cl. B32B 37/00; B29C 65/00; C09J 5/04; B29C 70/86

(52) U.S. Cl. 264/101; 156/307.4; 156/349; 264/258

(57) ABSTRACT

A multi-layered, variable-angled, non-crimped fabric for reinforcement of composite structures provides for holding the non-woven yarns as laid-out by adhesion of polymeric adhesive applied to the non-woven yarns. The adhesive layer on the yarns, dissolves as liquid resin is applied to form a composite structure, the polymeric coating dissolving in the liquid resin. The polymeric adhesive dissolves to allow liquid resin to wet-out the yarns. Curing creates the desired composite structure. Filament yarns useful in the present invention include but are not limited to those made of aramid, boron, carbon, fiberglass, nylon, PBO, PEN, polyester, and polyethylene. A preferred adhesive is low molecular weight polyester and a preferred liquid resin is polyester resin.

### CROSS REFERENCE TO RELATED APPLICATIONS:

This is a division application for application Ser. No. 11/005,210.

### BACKGROUND OF THE INVENTION 1. Field of the Invention

The present invention relates to textiles. More particularly, the present invention relates to fabrics useful as reinforcement in composite structures and the resulting structures.

2. Description of the Related Art

A known method of forming reinforced plastics articles and composites is to lay a mat of a non-woven or woven glass fiber or other reinforcement and wet-out the mat of material with a synthetic resin material, cure the resin, and remove the molded article from the mold. When a greater thickness of reinforced composites material is required in the molded article, then further mats of reinforcing material are laid upon the first, wetted-out, and cured. In addition, plates of reinforced composites materials may be formed suitable for cutting to create a desired article. Textile fabric materials useful as reinforcement in such composite structures typically are either woven or stitch-bonded fabrics, using yarns of fibers such as fiberglass, carbon, or aramid fibers. To form a useful article, each layer of the textile material must be fully wetted-out by the synthetic resin material before curing to avoid the creation of voids in the article, reducing its strength and integrity.

The advantage of a woven fabric in a composite structure is that the fabric is very pliable. This characteristic is advantageous when laying the fabric inside of an open or closed mold, where the resin is either applied or injected. The disadvantage of woven fabric in a composite structure is that a weave creates weak places in the yarn. This is due to how the yarns must go up-and-down in a weave forming crimps. These crimps form voids in the composite structure, which, in turn, create weak locations, in the finished composite structure.

For a non-woven fabric, such a stitch-bonded fabric, the yarns are non-crimped;

that is, there is no repeated up-and-down orientation of the yarn as in a woven fabric. The yarns in a non-woven, stitch-bonded fabric can be laid-out in a fabric machine direction (warp of 0 degrees), perpendicular to the machine direction (weft or filling of 90 degrees), or at a +45/±45 degree angle to the machine direction. The yarns in this type of fabric are non-crimped. The disadvantage, however, of this type of fabric is that the stitching yarns can be pulled out while the fabric is being laid-up in the mold and during the wetting-out with resin, thereby causing the 0 degree/90 degree/+45 degree/−45 degree yarns to fall apart.

To overcome this problem, the manufacturers of this type of fabric put additional warp-knitting yarns in place; however, this inhibits the flow of liquid resin throughout the fabric to fully wet-out the fabric as required for a desirable composite structure.

It would be desirable to provide a non-woven fabric for reinforcement of composite structures wherein the non-crimped yarn layers can be laid-out relative to the machine direction at a variable angle, as required by the specifications of the composite structure. Wherein, the yarns are held in place without stitch bonding yarns to avoid pulling out or attendant resin wetting problems.

Thus, a multi-layered, variable-angled, non-crimped fabric for reinforcement of composite structures solving the aforementioned problems is desired.

### SUMMARY OF THE INVENTION

The multi-layered, variable-angled, non-crimped fabric for reinforcement of composite structures of the present invention provides for the holding of the non-crimped yarns as laid-out relative to the machine direction of a variation of angles by adhesion of polymeric adhesive applied to the non-crimped yarns. The adhesive layer on the yarns dissolves as liquid resin is applied to form a composite structure, the polymeric coating dissolving in the liquid resin. The polymeric adhesive dissolves to allow the resin to wet-out the yarns, forming new bonds with the yarns, and curing to create the desired composite structure. The polymeric adhesive coating is directly applied to first web of yarns by applying the adhesive to the yarn in a finish bath, applying heat to the filament yarn to cure the polymeric coating and cooling to form a cured coating directly on the filament yarn. Then, a second layer of polymeric adhesive coated filament yarns is laid on top of the first layer of filament yarns and heat is applied to form a fabric with a variable angles. Additional layers of polymeric adhesive coated filament yarns can be added, as required by the specification for the composite structure.

During the resin application process, the resin penetrates the filament fabric layers and uniformly dissolves in the resin, as the filament fabric layers become part of the hardened cured resin matrix. Useful polymeric adhesive materials include but are not limited to low molecular weight acrylic, polyester, or polyurethane for the finish bath.

Filament yarns useful in the present invention include but are not limited to those made of aramid, boron, carbon, fiberglass, nylon, PBO, PEN, polyester, and polyethylene.

When manufacturing a composite structure, a bottom layer of the inventive reinforcement fabric is laid in a mold and liquid resin is applied. As the resin penetrates the reinforcement fabric (wet-out), other layers of the reinforcement fabric can be applied over the bottom layer and more liquid resin is added to wet this reinforcement fabric layer. This process is repeated, until the desired thickness is achieved.

It is an aspect of the invention to provide improved reinforcement fabric materials and composite products thereof for the purposes described which is inexpensive, dependable and fully effective in accomplishing its intended purposes.

These and other aspects of the present invention will become readily apparent upon further review of the following specification and drawings.

### BRIEF DESCRIPTION OF THE DRAWING

FIG. 1 is a perspective view of a multi-layered, variable-angled, non-crimped fabric for reinforcement of composite materials.

### DETAILED DESCRIPTION OF THE PREFERRED EMBODIMENTS

The present invention is multi-layered, variable-angled, non-crimped fabric for the reinforcement of composite structures. The term multi-layered, variable-angled, non-crimped fabric is defined as adhering layers of non-woven fabric having filament yarns laid at relative angles, for instance but not limited to, 0 degrees/90 degrees relative to a fabric-making machine.

The inventive reinforcement fabric employs a first web of coated, of non-woven, uni-directional fabric layer of filaments, the coating being of a low molecular weight polymer adhesive material. The fabric has multiple layers of non-woven, uni-directional fabric of filaments having a coating of the same adhesive material upon the filaments thereof and overlaid at an axial angle relative to the first layer of non-woven, unidirectional fabric, the layers of fabric being held by the adhesive between the first layer of fabric and the second layer of fabric. The axial angle is preferably, but not limited to, about 90 degrees. Filaments useful in the multi-layered, variable-angled, non-crimped fabric include filaments of boron, carbon, and fiberglass, and aramid, nylon, PBO, PEN, polyester and polyethylene polymers. The adhesive film on each layer of non-woven, unidirectional fabric of filaments is formed by treating in a finish bath of a low molecular weight polymer of acrylic, polyester, or polyurethane polymers.

A preferred method of forming the multi-layered, variable-angled, non-crimped fabric for the reinforcement of composite structures of the present invention include the following:

(1) Placing the filament yarns in a creel stand or warp beam;

(2) Drawing the filament yarns through a reed;

(3) Through tension, laying the individual filaments from the reed side-by-side to form a first web of reinforcement material;

(4) treating the first web of reinforcement material in a finish bath forming a thin, tacky adhesive polymeric film thereon;

(5) drawing the resulting unidirectional fiber web over a heating element to flash-off solvent and set the polymeric film to form a product unidirectional filament fabric;

(6) drawing the product fabric through a cooling zone; and

(7) winding the product fabric onto a primary roll.

If desired, the following steps may be taken to form a multi-layered, variable-angled, non-crimped reinforcement fabric material:

(8) placing the primary roll across a second web of side-by-side reinforcement yarns such as the product of step 4, in such a way above as to create a variable angle in the material and repeating the heating and cooling steps of steps 5 and 6, above.

(9) winding the product fabric onto a product roll.

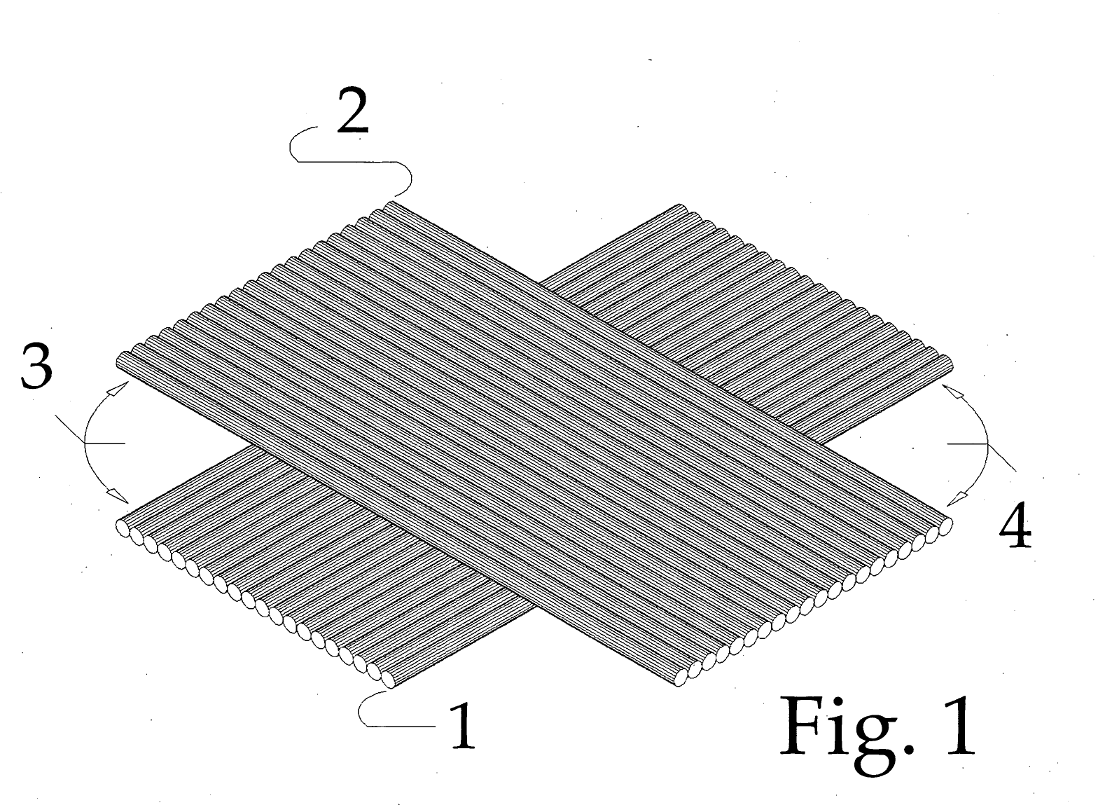

Referring to FIG. 1, there is shown an example of the multi-layered, variable-angled, non-crimped fabric before its use as a reinforcement of composite materials. Bottom layer (1) is indicated in the machine direction; however, it is possible to construct the single bottom layer with a variable angle (3) from 0 degrees to 90 degrees to the machine direction. If desired, another layer (2) can be adhered to the first layer (1) by use of polymeric adhesives, and it is possible to vary the angle (4) of the second layer. Additional layers with variable angles can be added, as desired (not shown).

### EXAMPLE

An example of a polymer and liquid bath is Eastman's WD-30 polyester. Polyester solids at a wt. percent level of 30% are suspended in water to form the polymer/liquid bath. These polyester solids are compatible with polyester resins and dissolve therein in the practice of the present invention. Other polymers which may be useful include, but are not limited to, epoxy polymer/liquid baths and epoxy resins, and phenolic polymer/liquid baths and phenolic resins.

Two types of fabric were manufactured on a pilot machine of van Wees: Tilburg, The Netherlands. The main characteristic of the pilot machine is that it has a 1,700 mm wide by 541 mm diameter heated drum. The yarns were drawn from a creel, through a reed, through an impregnation roller(the polymer bath) for a adding a binder, and onto a heated Teflon-coated drum that was wrapped with the carrier. The yarns advanced by pitch (depending on the width of the yarn) as the yarns complete one revolution around the drum, and the individual filaments of the yarns are laid side-by side until the yarns wrapped completely around the drum. The yarn/fabric was then cut perpendicular to the wrap around the drum, turned ninety degrees, and re-attached to the drum. The process was than repeated to give a 0 degree/90 degree fabric. A table of process parameters follows:

Multi-layered, Variable-angled, Non-crimped Fabric Information

| | |
|---|---|
| Specifications: | Fabric Identification: S/610 |

Yarn Information:

| | |
|---|---|
| Type: | Fiberglass Filament |
| Size, yield: | 247 |
| Number of Yarns in Creel: | 1 |
| Tension, cN: | Negligible |
| Pitch, mm: | 6.6 |

Reed Information:

| | |
|---|---|
| Openings per 10 cm: | N/A |

Matrix Information:

| | |
|---|---|
| Type: | WD-30 |
| Add-on, %: | 1.0 |

Drum Information:

| | |
|---|---|
| Circumferential Speed, m/min: | 20 |
| Surface Temperature, C. °: | 120 |
| Water Temperature, C. °: | 130 |

In the case of actual manufacturing, the heated drum from the pilot process may be replaced by a heated calendar or flat, heated Teflon-coated surface to flash-off the water from the binder.

In some applications, more than two coated filament yarn webs within a range of 0 degrees/90 degrees relative to each other may be cured employed as a reinforcement fabric and is within the scope of the present invention.

Examples of articles which may be produced according to the present invention include marine hulls, sports equipment, pipes, containers, automotive parts, and aircraft wings and fuselage.

The laid-up article may be cured by any conventional means such as vacuum bag pressure and heat, or pressure autoclave to form the finished composite article.

It is to be understood that the present invention is not limited to the embodiments described above, but encompasses any and all embodiments within the scope of the following claims.

I claim the following:

1) A machine that can produce a multi-layered, variable-angled, non-crimped fabric; wherein, the variable-angles of the individual layers can be pre-determined by the fabric engineer on the machine that is not limited to a pre-set angle,

2) A method of forming a changeable fabric for the reinforcement of composite structures comprising the following:
a) Treating a first layer of uni-directional fabric of filaments in a finish bath forming an adhesive coating thereon;
b) Laying said treated first web of non-woven uni-directional fabric of filaments on a flat support surface;
c) Setting the machine to a pre-determined angle, where the angle can be set by the fabric engineer and treating more layers of multi-layered, variable-angled, non-crimped filaments in a said finish bath forming a thin adhesive film thereon; and
d) Overlaying another layer of web of non-woven uni-directional filaments on said first web of uni-directional fabric of filaments at an axial angle relative to said first web of non-woven uni-directional fabric;
e) Setting said adhesive coating bonding to said second layer to said first layer forming a layered reinforcement fabric;
f) Creating more than two layers of multi-layered, variable-angled, non-crimped fabric by overlaying other layers of web of non-woven uni-directional filaments on said existing web of uni-directional fabric of filaments at an axial angle relative to said existing web of non-woven uni-directional fabric;

3) The method of forming a reinforcement fabric of claim 2, wherein said filaments of said multi-layered, variable-angled, non-crimped fabric are selected from the group comprising, but not limited to, boron, carbon, fiberglass, aramid, nylon, PBO, PEN, polyester, and polyethylene polymers.

4) The method of forming a reinforcement fabric of claim 2, wherein said adhesive coating includes the following, but not limited to, low-molecular weight adhesives such as polyester, epoxy, and styrene.

5) A method of forming a finished composite article comprising the following:
a) Laying the multi-layered, variable-angled, non-crimped fabric of claim 2 in a supporting mold;
b) Applying a liquid resin selected from the group from claim 4 to said multi-layered, variable-angled, non-crimped fabric as to uniformly wet-out said fabric;
c) Repeating said overlaying of multi-layered, variable-angled, non-crimped fabric and said liquid resin application steps to form a laid-up article of the thickness desired; and
d) Curing said laid-up article to form a finished composite article.

6) The method of claim 5, wherein said laid-up article is cured by vacuum-bag pressure to form said finished composite article.
